(19) United States
(12) Patent Application Publication
(10) Pub. No.: US 2012/0150529 A1
(43) Pub. Date: Jun. 14, 2012

(54) METHOD AND APPARATUS FOR GENERATING TRANSLATION KNOWLEDGE SERVER

(75) Inventors: Chang Hyun KIM, Daejeon (KR); Young Ae Seo, Daejeon (KR); Seong Il Yang, Daejeon (KR); Jin Xia Huang, Daejeon (KR); Sung Kwon Choi, Daejeon (KR); Yoon Hyung Roh, Daejeon (KR); Ki Young Lee, Daejeon (KR); Oh Woog Kwon, Daejeon (KR); Yun Jin, Daejeon (KR); Eun Jin Park, Daejeon (KR); Jong Hun Shin, Busan (KR); Young Kil Kim, Daejeon (KR); Sang Kyu Park, Daejeon (KR)

(73) Assignee: Electronics and Telecommunication Research Institute, Daejeon (KR)

(21) Appl. No.: 13/316,369

(22) Filed: Dec. 9, 2011

(30) Foreign Application Priority Data
Dec. 9, 2010 (KR) 10-2010-0125870

(51) Int. Cl. G06F 17/28

(52) U.S. Cl. 704/2

(57) ABSTRACT

A method and apparatus for generating a translation knowledge server, which can generate a translation knowledge server based on translation knowledge collected in real time is provided. The apparatus for generating translation knowledge server may include: data collector which collects initial translation knowledge data; data analyzer which performs morphological analysis and syntactic analysis on the initial translation knowledge data received from the data collector and outputs analyzed data; and translation knowledge learning unit which learns real-time translation knowledge by determining target word for each domain from the analyzed data based on predetermined domain information or by determining a domain by automatic clustering. According to the present invention, it is possible to obtain translation knowledge by analyzing documents present in a web or provided by a user in real time and to improve the quality of translation by applying the obtained translation knowledge to a translation engine.

### CROSS-REFERENCE TO RELATED PATENT APPLICATION

This application claims the benefit of Korean Patent Application No. 10-2010-0125870, filed on Dec. 9, 2010, in the Korean Intellectual Property Office, the disclosure of which is incorporated herein in its entirety by reference.

### BACKGROUND OF THE INVENTION

1. Field of the Invention

The present invention relates to a translation knowledge server and, more particularly, to a method and apparatus for generating a translation knowledge server, which can generate a translation knowledge server based on translation knowledge collected in real time.

2. Description of the Related Art

Recently, with the increase of international exchange, the use of machine translation which promotes cultural exchange between different languages is also increasing. Here, it is very important to improve the accuracy of the machine translation. Typically, there are two methods to improve the performance of the conventional machine translation system: one is a method for constructing translation knowledge using a large amount of corpora and the other is a method for expanding a large amount of domain knowledge.

First, according to the method for constructing the translation knowledge, linguistic knowledge is extracted from a large amount of corpora using rules or statistical information, and a person having linguistic knowledge inputs the extracted linguistic knowledge to a translation dictionary. Second, the method for expanding a large amount of domain knowledge is to continuously expand the domain knowledge which will be used in the machine translation system. Especially, in order to achieve automatic translation of high quality in a specific domain, it is necessary to newly construct knowledge suitable for the corresponding domain and, at the same time, to specialize the pre-constructed knowledge and the translation system to make them suitable for the domain. To this end, specialized operations such as construction of new words and patterns, tuning of engine errors, correction of pre-constructed knowledge, etc. are required. These operations are typically performed by a trained bilingual linguist.

However, it is very difficult to find such a trained bilingual linguist and further it is necessary for the linguist to read a large number of translated sentences, which requires considerable time and effort. Therefore, considerable time and expense is required to produce high quality translation in a specific domain, and the efficiency of translation is significantly reduced.

To increase the translation efficiency, a method for constructing translation knowledge by collecting a large amount of data offline and batch processing the data has been used. As a result, it is very difficult to construct accurate translation knowledge in real time with respect to documents which are required to be translated and are registered every day, and thus the quality of the automatic translation is reduced.

In terms of source text error correction, according to existing methodologies, the best way is to provide a specific guideline to users such that the users write source texts in accordance with the corresponding guideline. Moreover, the users are requested to refer to guidelines made by other users so as to solve the problem due to lack of guidelines. However, the guidelines themselves are vague and, if the number of guidelines increases, it is impractical for the users to comply with numerous guidelines and then perform the automatic translation.

In terms of errors in translation knowledge/translation engines, while the development of the translation engines has continued, the errors in translation knowledge are corrected by people individually or collectively, and the errors in translation engines are also corrected in a similar manner. However, this method requires professionals continuously to improve the knowledge and correct the errors in the translation engines, and much time is required to identify the errors and improve the translation engines and knowledge.

### SUMMARY OF THE INVENTION

The present invention has been made in an effort to solve the above-described problems associated with prior art.

Therefore, a first object of the present invention is to provide an apparatus for generating a translation knowledge server based on translation knowledge collected in real time.

A second object of the present invention is to provide a method for generating a translation knowledge server based on translation knowledge collected in real time.

According to an aspect of the present invention to achieve the first object of the present invention, there is provided an apparatus for generating a translation knowledge server, the apparatus comprising: a data collector which collects initial translation knowledge data; a data analyzer which performs morphological analysis and syntactic analysis on the initial translation knowledge data received from the data collector and outputs analyzed data; and a translation knowledge learning unit which learns real-time translation knowledge by determining a target word for each domain from the analyzed data based on predetermined domain information or by determining a domain by automatic clustering.

According to another aspect of the present invention to achieve the second object of the present invention, there is provided a method for generating a translation knowledge server, the method comprising: collecting initial translation knowledge data; performing morphological analysis and syntactic analysis on the collected initial translation knowledge data and outputting analyzed data; and learning real-time translation knowledge by determining a target word for each domain from the analyzed data based on predetermined domain information or by determining a domain by automatic clustering.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing an internal structure of an apparatus for generating a translation knowledge server in accordance with an exemplary embodiment of the present invention; and

FIG. 2 is a flowchart illustrating a method for generating a translation knowledge server in accordance with another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

Meanwhile, in exemplary embodiments of the present invention which will be described below, an example in which a Korean input sentence is translated into English will be described. However, the input sentence and translated language are not necessarily limited to the Korean and English languages.

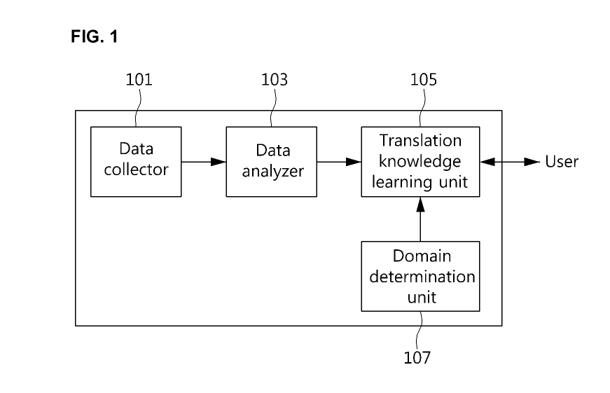

FIG. 1 is a block diagram showing an internal structure of an apparatus for generating a translation knowledge server in accordance with an exemplary embodiment of the present invention.

Referring to FIG. 1, an apparatus for generating a translation knowledge server may comprise a data collector 101, a data analyzer 103, a translation knowledge learning unit 105, and a domain determination unit 107.

The data collector 101 identifies and collects initial translation knowledge data in real time. The data collector 101 may identify the initial translation knowledge data in real time using two methods. First, a method in which the data collector 101 identifies the initial translation knowledge data in real time by automatic identification will now be described. According to an exemplary embodiment of the present invention, the data collector 101 may identify the translation knowledge by collecting parallel/single corpora present in a web in real time and removing tags such as HTML(Hyper Text Markup Language) etc.

Here, the term “corpus” means a collection of texts written by a writer or a collection of texts in a particular field, and thus it has the meaning of a bundle of words. The corpus may be configured in various ways depending on the data collection or the purpose of research. For example, if the purpose of research is a general corpus, the corpus may include corpora constructed in the 21^{st} century Sejong Project and, if the purpose of research is a special purpose corpus, the corpus may include a corpus for analysis of English used by health care workers, a corpus for analysis of language used by a specific age, etc.

Second, a method in which the data collector 101 identifies the initial translation knowledge in real time by manual identification will now be described. According to an exemplary embodiment of the present invention, the data collector 101 may receive initial translation knowledge data collected by a user manually and transmit the received data to the data analyzer 103.

The data analyzer 103 receives the initial translation knowledge such as monolingual data or bilingual data from the data collector 101, analyzes the received translation knowledge data, and outputs analyzed translation knowledge data such as knowledge for morphological analysis, co-occurrence information knowledge for syntactic analysis, target word knowledge, etc. Here, the translation knowledge data analyzed by the data analyzer 103 is stored to correspond to domain information determined by the domain determination unit 107.

First, a method in which the data analyzer 103 receives and analyzes the monolingual data from the data collector 101 will be described. According to an exemplary embodiment of the present invention, if the monolingual data received from the data collector 101 is Korean monolingual data, the data analyzer 103 separates words contained in the received Korean input sentence in a spacing unit using spaces (blanks) as phrase separators based on the fact that the phases are spaced out in the received Korean monolingual data and performs morphological analysis on the words separated in a spacing unit such as “noun+particle”, “predicate+final ending”, “predicate+pre-final ending+finding ending”, “predicate+none ending+predicative particle+pre-final ending+finding ending”, etc. Here, a morpheme is a basic unit for analysis of the input sentence and means the smallest grammatical unit, which cannot be further analyzed, as a meaningful word. For example, the morpheme includes the minimum units, which lose their meaning when they are further analyzed, such as the root of a word, a single ending, a particle, a prefix, a suffix, etc.

Moreover, according to an exemplary embodiment of the present invention, if the received Korean monolingual data is “Chulsoo behaves annoyingly”, for example, since the word “behaves” is an intransitive verb, only the subject is regarded as an essential ingredient, and thus the data analyzer 103 analyzes the input sentence as a correct sentence. Next, a method in which the data analyzer 103 receives Korean monolingual data from the data collector 101 and analyzes the data will be described with reference to example sentences below.

### EXAMPLE SENTENCE 1

Sony wiki-eui geunbon-eun wiki euisik-eui bujae-ida.

(In English: The fundamental cause of Sony's crisis is the lack of a sense of crisis.)

### EXAMPLE SENTENCE 2

Sony-reul gajang yumyung-hage mandeun jepum-eun Walkman-ida.

(In English: The product that made Sony the most famous company is Walkman.)

Referring Example sentences 1 and 2, the data analyzer 103 performs the morphological analysis by classifying “Sony” as “So/verb+ny/ending” in Example sentence 1 and “Sony” as “Sony/proper noun+reul/particle” in Example sentence 2. That is, through the analysis of the data analyzer 103, the proper noun “Sony” can be used in the entire analysis of Example sentences 1 and 2. Next, a method in which the data analyzer 103 receives Korean monolingual data from the data collector 101, analyzes the data, and then outputs co-occurrence information knowledge as the analyzed translation knowledge data will be described with reference to Example sentence 3 below.

### EXAMPLE SENTENCE 3

Naeil-eun jeju-wa nambu jibang-eseo bi-ga ogekko, bam-eneun jungbu jibang-esoedo chacheum naerigesseumnida.

(In English: It will rain in Jeju and the southern districts tomorrow, and it will rain also in the central districts tomorrow night.)

Referring to Example sentence 3, since the word “naeil-eun” (in English “tomorrow”) has a syntactic relation with both the word “ogekko” (in English “will rain”) and the word “naerigesseumnida” (in English “will rain”), it is difficult to for the data analyzer 103 to perform accurate syntactic analysis, and thus the words are excluded from the extraction of co-occurrence information. Moreover, in the case of the words “jeju-wa nambu jibang-eseo” (in English “in Jeju and the southern districts”), the data analyzer 103 analyzes that they may have a syntactic relation with both the word “ogekko” and the word “naerigesseumnida”. However, since there is a comma (“,”) as a sentence separator after the word “ogekko”, the data analyzer 103 analyzes that the words “nambu jibang-eseo”+“ogekko” have a correct syntactic relation and thus extracts the words “nambu jibang-eseo” and “ogekko” as co-occurrence information. Further, the data analyzer 103 analyzes that the words “jungbu jibang-esoedo” (in English “also in the central districts”) may have a syntactic relation only with the word “naerigesseumnida” and extracts the words “jungbu jibang-esoedo”+“naerigesseumnida” as co-occurrence information.

Second, a method in which the data analyzer 103 receives bilingual data from the data collector 101 and analyzes the data will be described below. According to an exemplary embodiment of the present invention, if the received bilingual data is Korean/English bilingual data, the data analyzer 103 performs morphological analysis and syntactic analysis on the Korean/English bilingual data received from the data collector 101 and performs arrangement of words in units of words. Next, a method in which the data analyzer 103 receives Korean/English bilingual data from the data collector 101 and analyzes the data will be described with reference to Example sentence 4 below.

### EXAMPLE SENTENCE 4

Bae-ga hangu-e jungbakhaeiseumnida.

→A ship is in port.

Referring to Example sentence 4, the data analyzer 103 performs morphological analysis on the Korean sentence “Bae-ga hangu-e jungbakhae isseumnida” out of the received Korean/English bilingual data in which the phases contained in the received Korean input sentence are separated in a spacing unit using the spaces as phrase separators based on the fact that the phases are spaced out in Korean language as follows: “bae/proper none+ga/nominative particle”, “hangu/common noun+e/adverbial particle”, and “jungbakha/verb+ei/auxiliary predicate+seumnida/sentence ending”.

The data analyzer 103 performs morphological analysis on the English sentence “A ship is in port” in which the words contained in the received English input sentence are separated in a spacing unit using the spaces as word separators based on the fact that the English words are spaced out in the English sentence to generate “A”, “ship”, “is”, “in”, and “port” and to determine the parts of speech of the generated words in such a manner that, for example, “A” is an article, “ship” is a none, “is” is a verb, “in” is a preposition, and “port” is a none.

### EXAMPLE SENTENCE 5

Younghee-neun bae-eui tongjeung-euro byungwon-e qaseumnida.
→Younghee went the hospital due to pain in abdomen. Referring to Example sentence 5, the data analyzer 103 performs morphological analysis on the Korean sentence “Younghee-neun bae-eui tongjeung-euro byungwon-e gaseumnida” out of the received Korean/English bilingual data to extract morphological information such as “bae/none”. Moreover, the data analyzer 103 performs morphological analysis on the received English sentence.

The translation knowledge learning unit 105 determines target words for each domain from the data analyzed by the data analyzer 103. First, the translation knowledge learning unit 105 determines a domain of translation knowledge based on domain information determined by the domain determination unit 107. That is, the translation knowledge learning unit 105 determines a set of main keywords, which are closely related to a corresponding domain, for each domain received from the domain determination unit 107 and determines a domain by calculating the correlation with the set of keywords. According to an exemplary embodiment of the present invention, the translation knowledge learning unit 105 receives domain information such as “medical treatment”, “fruit”, and “ship” from the domain determination unit 107. Then, based on the data analyzed by the data analyzer 103, a target word of “bae” is determined as “abdomen” in the domain of “medical treatment” and stored, and a target word of “bae” is determined as “pear” in the domain of “fruit” and stored, and a target word of “bae” is determined as “boat” in the domain of “ship” and stored. The translation knowledge learning unit 105 extracts such information in real time and reflects the extracted information in a translation engine, thereby selecting an accurate target word. Moreover, the translation knowledge learning unit 105 may determine a domain by automatic clustering without specifying the domain.

The translation knowledge learning unit 105 may learn real-time translation knowledge data through user participation by the following three methods. First, the translation knowledge learning unit 105 may learn the translation knowledge data through a source text error learning method.

When a translation is generated by translating the Korean source text into a target language, one of the most significant factors that affect the quality of the translation is the completeness of the source text. If the Korean source text is perfect, the quality of the translation into the target language is good; otherwise, the quality of the translation is significantly reduced. Further, the Korean language is an agglutinative language, in which there are a number of errors in the combination of morphemes, spacing, etc. For these reasons, the translation knowledge learning unit 105 performs source text error correction through the source text error learning method. Next, a method in which the translation knowledge learning unit 105 corrects a source text error through the source text error learning method will be described with reference to Example sentence 6 below.

### EXAMPLE SENTENCE 6

Munseo beonyeok-eul jadong beonyeok-eul iyonghamyun pareun beonyeok-i ganeunghada.

(In English: If document translation and automatic translation are used, quick translation is possible.)

Referring to Example sentence 6, if a user writes a sentence with double objects such as “Munseo beonyeok-eul jadong beonyeok-eul” (In English: “document translation and automatic translation”), the translation knowledge learning unit 105 detects an error based on the source text error learning result and reports an error message such as “the use of dual objects” to the user. Then, the user corrects the “Munseo beonyeok-eul” to “Munseo beonyeok-e” (in English: “in document translation”). Thus, the translation knowledge learning unit 105 receives the error correction information on the initial translation knowledge data from the user and learns a pattern rule, thereby applying the learned rule in real time.

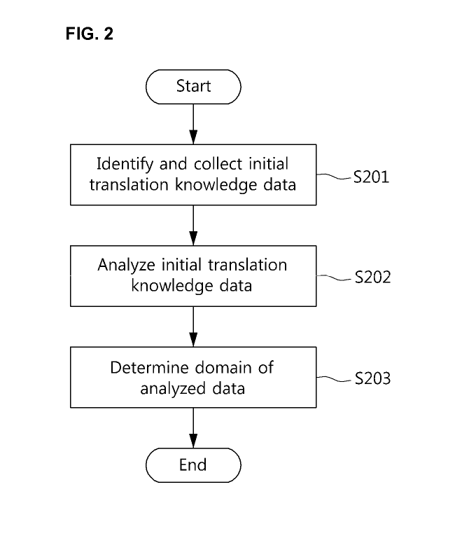

According to second and third methods, the translation knowledge learning unit 105 may learn the translation knowledge data through a translation knowledge error leaning method and a translation engine error learning method. According to an exemplary embodiment of the present invention, the translation knowledge learning unit 105 provides an error in the translation result of the initial translation knowledge data and an intermediate result for each module of the translation engine to the user, and the user corrects the error based on the intermediate result and reports the error information. Then, the translation knowledge learning unit 105 learns the error information on the translation engine and the translation knowledge reported by the user, thereby applying the learned rule in real time. Therefore, the quality of the translation can be improved and, further, the learned rule can be stored as error learning data in the corresponding domain and utilized in translation by other users in the future. Next, a method for generating a translation knowledge server in accordance with another exemplary embodiment of the present invention will be described in more detail with reference to FIG. 2 below.

FIG. 2 is a flowchart illustrating a method for generating a translation knowledge server in accordance with another exemplary embodiment of the present invention.

Referring to FIG. 2, an apparatus for generating translation knowledge server identifies and collects initial translation knowledge data in real time by automatic identification and manual identification (S201). First, a process of identifying and collecting the initial translation knowledge data in real time by automatic identification will be described below. The apparatus for generating the translation knowledge server may identify the translation knowledge by collecting parallel/single corpora present in a web in real time and removing tags such as HTML etc.

Here, the term “corpus” means a collection of texts written by a writer or a collection of texts in a particular field, and thus it has the meaning of a bundle of words. The corpus may be configured in various ways depending on the data collection or the purpose of research. For example, if the purpose of research is a general corpus, the corpus may include corpora constructed in the 21^{st} century Sejong Project and, if the purpose of research is a special purpose corpus, the corpus may include a corpus for analysis of English used by health care workers, a corpus for analysis of language used by a specific age, etc.

Second, a process of identifying and collecting the initial translation knowledge in real time by manual identification will now be described. The apparatus for generating the translation knowledge server may receive initial translation knowledge data collected by a user manually.

The apparatus for generating the translation knowledge server analyzes the initial translation knowledge (S202). Here, the initial translation knowledge data may include monolingual data and bilingual data. First, the case where the initial translation knowledge data is monolingual data will be described below. According to an exemplary embodiment of the present invention, the apparatus for generating the translation knowledge server separates words contained in the received Korean input sentence in a spacing unit using spaces (blanks) as phrase separators based on the fact that the phases are spaced out in the received Korean monolingual data and performs morphological analysis on the words separated in a spacing unit such as “noun+particle”, “predicate+final ending”, “predicate+pre-final ending+finding ending”, “predicate+none ending+predicative particle+pre-final ending+finding ending”, etc. Here, a morpheme is a basic unit for analysis of the input sentence and means the smallest grammatical unit, which cannot be further analyzed, as a meaningful word. For example, the morpheme includes the minimum units, which lose their meaning when they are further analyzed, such as the root of a word, a single ending, a particle, a prefix, a suffix, etc.

Moreover, according to an exemplary embodiment of the present invention, if the apparatus for generating the translation knowledge server receives and analyzes Korean monolingual data such as “Chulsoo behaves annoyingly”, since the word “behaves” is an intransitive verb, only the subject is regarded as an essential ingredient, and thus the apparatus for generating the translation knowledge server analyzes the input sentence as a correct sentence.

Second, the case where the initial translation knowledge data is bilingual data will be described below. According to an exemplary embodiment of the present invention, if the initial translation knowledge data is bilingual data, the apparatus for generating the translation knowledge server performs morphological analysis and syntactic analysis on the received Korean/English bilingual data and performs arrangement of words in units of words.

The apparatus for generating the translation knowledge server determines a domain of the analyzed data (S203). First, the apparatus for generating the translation knowledge server determines a domain of translation knowledge based on predetermined domain information. That is, the apparatus for generating the translation knowledge server determines a set of main keywords, which are closely related to a corresponding domain, for each predetermined domain and determines a domain by calculating the correlation with the set of keywords. According to an exemplary embodiment of the present invention, the apparatus for generating the translation knowledge server receives predetermined domain information such as “medical treatment”, “fruit”, and “ship”. Then, based on the data analyzed by a data analyzer, a target word of “bae” is determined as “abdomen” in the domain of “medical treatment” and stored, and a target word of “bae” is determined as “pear” in the domain of “fruit” and stored, and a target word of “bae” is determined as “boat” in the domain of “ship” and stored. The apparatus for generating the translation knowledge server extracts such information in real time and reflects the extracted information in a translation engine, thereby selecting an accurate target word. Moreover, the apparatus for generating the translation knowledge server may determine a domain by automatic clustering without specifying the domain.

Moreover, if a user writes a sentence with double objects such as “Munseo beonyeok-eul jadong beonyeok-eul” (In English: “document translation and automatic translation”) like the above-described Example sentence 6, the apparatus for generating the translation knowledge server detects an error based on the source text error learning result and reports an error message such as “the use of dual objects” to the user. Then, the user corrects the “Munseo beonyeok-eul” to “Munseo beonyeok-e” (in English: “in document translation”). Thus, the apparatus for generating the translation knowledge server receives the error correction information on the initial translation knowledge data from the user and learns a pattern rule, thereby applying the learned rule in real time.

As described above, according to the translation knowledge server based on the translation knowledge collected in real time in accordance with the present invention, it is possible to obtain translation knowledge by analyzing the documents present in a web or provided by a user in real time and to improve the quality of translation by applying the obtained translation knowledge to a translation engine. Moreover, it is possible to provide a higher quality of translation by applying different knowledge to each domain. Furthermore, the source text error, translation knowledge error, and the translation engine error can be fed back in real time through user participation to perform learning of the errors, and thus it is possible to use the error correction information and feedback from all users who use the corresponding translation server, thereby providing a higher quality than the users expect.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An apparatus for generating a translation knowledge server, the apparatus comprising:
a data collector which collects initial translation knowledge data;
a data analyzer which performs morphological analysis and syntactic analysis on the initial translation knowledge data received from the data collector and outputs analyzed data; and
a translation knowledge learning unit which learns real-time translation knowledge by determining a target word for each domain from the analyzed data based on predetermined domain information or by determining a domain by automatic clustering.

2. The apparatus of claim 1, wherein the translation knowledge learning unit receives error correction information on the initial translation knowledge from a user and learns a pattern rule of the received error correction information in real time.

3. The apparatus of claim 1, wherein the translation knowledge learning unit receives at least one of translation knowledge error information or translation engine error information from a user and learns a pattern rule in real time.

4. The apparatus of claim 1, wherein the translation knowledge data is monolingual data or bilingual data.

5. The apparatus of claim 1, wherein the data collector collects real-time initial translation knowledge by automatic identification or manual identification.

6. A method for generating a translation knowledge server, the method comprising:
collecting initial translation knowledge data;
performing morphological analysis and syntactic analysis on the collected initial translation knowledge data and outputting analyzed data; and
learning real-time translation knowledge by determining a target word for each domain from the analyzed data based on predetermined domain information or by determining a domain by automatic clustering.

7. The method of claim 6, wherein in the learning the real-time translation knowledge, error correction information on the initial translation knowledge is received from a user and a pattern rule of the received error correction information is learned in real time.

8. The method of claim 6, wherein in the learning the real-time translation knowledge, at least one of translation knowledge error information or translation engine error information is received from a user and a pattern rule is learned in real time.

9. The method of claim 6, wherein the translation knowledge data is monolingual data or bilingual data.

10. The method of claim 6, wherein in the collecting the initial translation knowledge data, real-time initial translation knowledge is collected by automatic identification or manual identification.
